(19) United States
(12) Patent Application Publication
(10) Pub. No.: US 2015/0322866 A1
(43) Pub. Date: Nov. 12, 2015

(54) Enhanced Turbine Cooling System Using a Blend of Compressor Bleed Air and Turbine Compartment Air

(71) Applicant: General Electric Company, Schenectady, NY (US)

(72) Inventors: Alston Ilford Scipio, Atlanta, GA (US); Robert Frank Hoskin, Atlanta, GA (US); Jason Brian Shaffer, Atlanta, GA (US); Sanji Ekanayake, Atlanta, GA (US)

(73) Assignee: General Electric Company, Schenectady, NY (US)

(21) Appl. No.: 14/274,885

(22) Filed: May 12, 2014

(51) Int. Cl. F02C 9/18; F02C 7/18

(52) U.S. Cl. CPC F02C 9/18; F02C 7/18

(57) ABSTRACT

The present application provides a gas turbine engine for low turndown operations. The gas turbine engine may include a compressor with a compressor bleed air flow, a turbine compartment with a turbine compartment air flow, a turbine, and an eductor. The eductor blends the compressor bleed air flow and the turbine compartment air flow into a blended air flow for use in cooling the turbine.

### TECHNICAL FIELD

The present application and the resultant patent relate generally to gas turbine engines and more particularly relate to an enhanced turbine cooling system using a blend of compressor bleed air and turbine compartment air for cooling in extreme turndown operations.

### BACKGROUND OF THE INVENTION

The demand on an electric grid may vary greatly on a day to day basis and even on an hour to hour basis. These variations may be particularly true in geographic regions with a significant percentage of renewables such as wind, solar, and other types of alternative energy sources. Overall gas turbine and power plant efficiency, however, generally requires gas turbine operation at base loads. Any reduction from base load may not only reduce efficiency but also may decrease component lifetimes and may increase undesirable emissions.

Nonetheless, there is a commercial need for spinning reserves to accommodate this variation in the load on the grid. Given such, there is a desire for traditional generating units to have “hibernation” capacity. That is, a generating unit is online but operating at an extremely low power, output, i.e., extreme turndown loads. Such an operating mode is largely inefficient because valuable energy in the compressor air flow is discharged as bleed air and as such may be wasted. Moreover, compressor stall or surge may be a risk.

Current generating units may be limited to a hibernation mode of approximately forty-five percent (45%) or so of base load for an extended duration. Any further turndown may result in inadequately cooled turbine stage buckets as well as possibly exceeding component operating constraints, i.e., “a pinch point” in later turbine stages. Specifically, mechanical property limits, operational parameter limits, and emission limits may have an impact on the overall turndown percentage that may be reached safely.

There is thus a desire for improved gas turbine cooling systems so as to provide adequate cooling even during extreme turndown operations without the loss of overall efficiency, a decrease in component lifetime, or an increase in undesirable emissions. Moreover, the gas turbine engine should maintain the ability to ramp up quickly to base load when needed.

### SUMMARY OF THE INVENTION

The present application and the resultant patent thus provide a gas turbine engine for low turndown operations. The gas turbine engine may include a compressor with a compressor bleed air flow, a turbine compartment with a turbine compartment air flow, a turbine, and an eductor. The eductor blends the compressor bleed air flow and the turbine compartment air flow into a blended air flow for use in cooling the turbine.

The present application and the resultant patent further provide a method of operating a gas turbine engine at low turndown. The method may include the steps of operating the gas turbine engine at less than about thirty percent (30%) of base load, directing a compressor bleed air flow to an eductor, directing a turbine compartment air flow to the eductor, blending the compressor bleed air flow and the turbine compartment air flow within the eductor into a blended air flow, and providing the blended air flow to a turbine to cool one or more stages therein.

The present application and the resultant patent further provide a low turndown cooling system for use with a gas turbine engine. The turndown cooling system may include a compressor bleed air flow from a compressor of the gas turbine engine, a turbine compartment air flow from a turbine compartment air source, and an eductor for blending the compressor bleed air flow and the turbine compartment air flow into a blended air flow for cooling one or more stages of a turbine of the gas turbine engine.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine showing a compressor, a combustor, a turbine, and a load.

FIG. 2 is a schematic diagram of a gas turbine engine with a turndown cooling system as may be described herein.

FIG. 3 is a further schematic diagram of the turndown cooling system of FIG. 2.

FIG. 4 is a schematic diagram of an alternative embodiment of a turndown cooling system.

### DETAILED DESCRIPTION

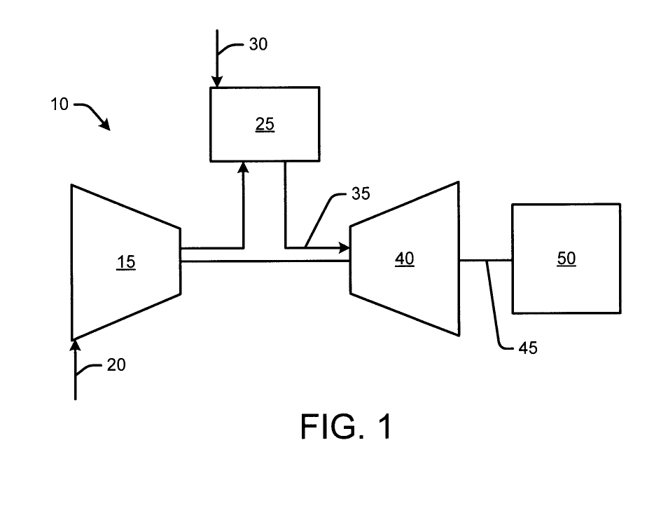

Referring now to the drawings, in which like numerals refer to like elements throughout the several views, FIG. 1 shows a schematic diagram of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25 positioned in a circumferential array or otherwise. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, liquid fuels, various types of syngas, and/or other types of fuels and combinations thereof. The gas turbine engine 10 may be any one of a number of different gas turbine engines offered by General Electric Company of Schenectady, N.Y., including, but not limited to, those such as a Frame 6, 7, or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

The gas turbine engine 10 may be part of a combined cycle system (not shown). Generally described in a typical combined cycle system, the flow of hot exhaust gases from the turbine 40 may be in communication with a heat recovery steam generator or other type of heat exchange device. The heat recovery steam generator, in turn, may be in communication with a multi-stage steam turbine and the like so as to drive a load. The load may be same load 50 driven by the gas turbine engine 10 or a further load or other type of device. Other components and other configurations also may be used herein.

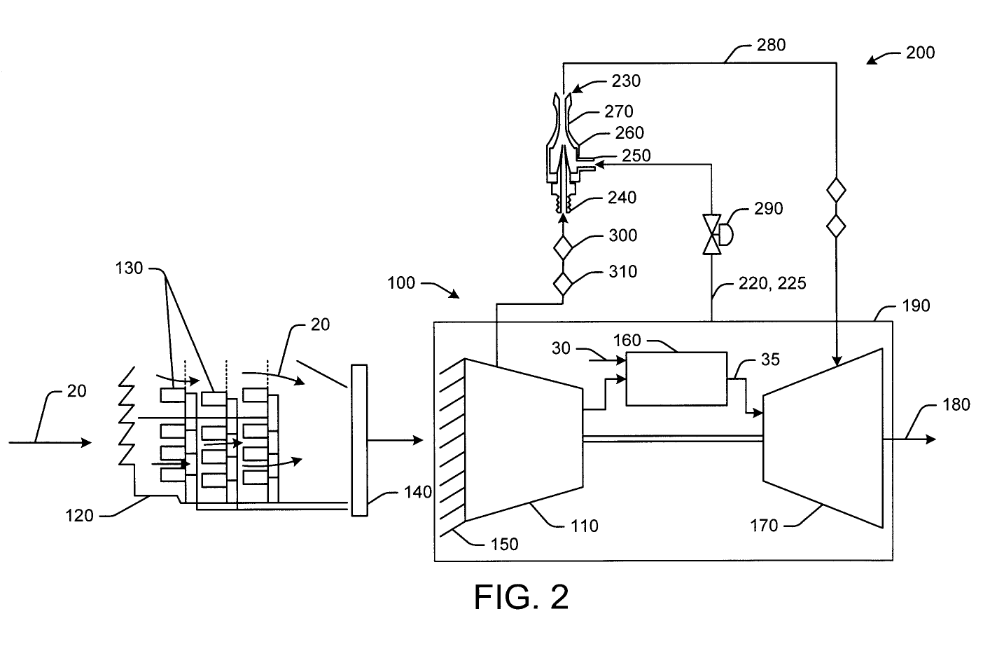

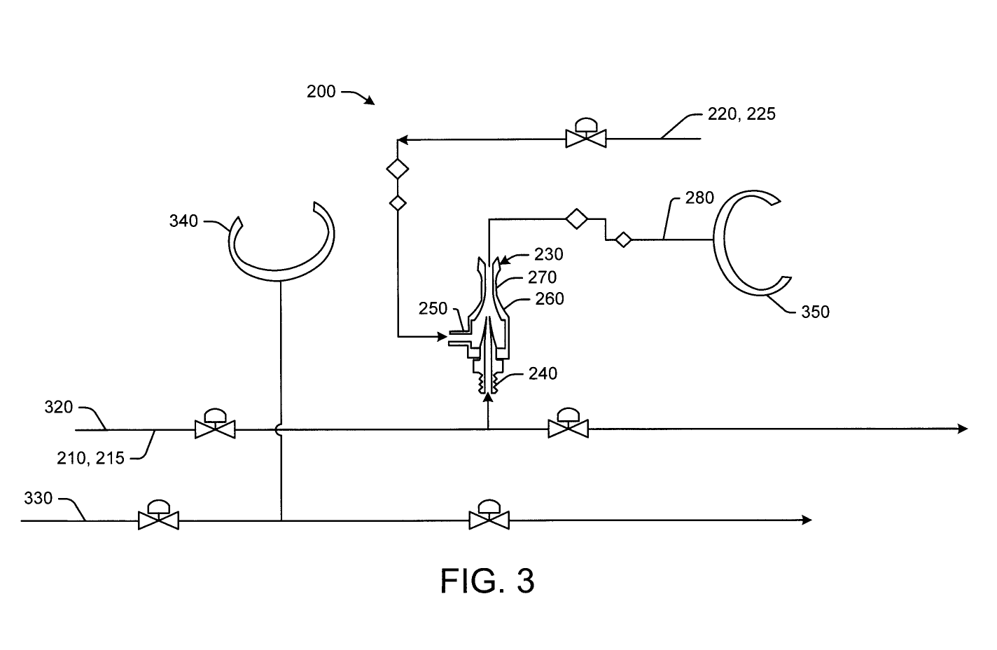

FIGS. 2 and 3 show an example of a gas turbine engine 100 as may be described herein. The gas turbine engine 100 may include a compressor 110. The flow of air 20 may be fed to the compressor 110 via an inlet filter house 120. The inlet filter house 120 may have a number of filters 130 therein. The flow of air 20 also may be warmed by an inlet bleed heat manifold 140. The inlet bleed heat manifold 140 may be in communication with the flow of compressor bleed or otherwise. The compressor 110 also may have a number of inlet guide vanes 150 positioned thereon so as to vary the angle of the incoming flow of air 20. The compressor 110, the inlet filter house 120 with the filters 130, the inlet bleed heat manifold 140, and the inlet guide vanes 150 may be of conventional design and have any suitable size, shape, configuration, or capacity. Other components and other configurations may be used herein.

The gas turbine engine 100 also may include a combustor 160 in communication with the flow of air 20 and the flow of fuel 30. As described above, the combustor 160 delivers the flow of combustion gases 35 to the turbine 170. In turn, a flow of exhaust gases 180 may exit the turbine 170 and may be sent to a heat recovery steam generator, an exhaust stack, or elsewhere. The turbine 170 and other components of the gas turbine engine 100 may be positioned within a turbine compartment 190. During operation of the gas turbine engine 100, waste heat may be released into the turbine compartment 190, which in turn may heat the air therein. This waste heat is generally vented to the atmosphere or otherwise dissipated. Other components and other configurations may be used herein.

The gas turbine engine 100 may include a turndown cooling system 200. The turndown cooling system 200 may include a compressor bleed air source 210 with a flow of compressor bleed air 215. The compressor bleed air source 210 may be compressor discharge air, compressor discharge casing extraction air, and the like. The turndown cooling system 200 also may include a turbine compartment air source 220 with a flow of turbine compartment air 225. The turbine compartment air source 220 may be in communication with the turbine compartment 190 or elsewhere via a duct with appropriate dampers, blowers, and controls so as to obtain the turbine compartment air flow 225. The turbine compartment air source 220 may be filtered and/or otherwise treated.

The compressor bleed air flow 215 and the turbine compartment air flow 225 may meet at an eductor 230. The eductor 230 is a mechanical device without any moving parts. The eductor 230 mixes two fluid streams based upon a momentum transfer between a motive fluid and a suction fluid. A motive inlet 240 may be in communication with the compressor bleed air flow 215. The eductor 230 also may include a suction inlet 250. The suction inlet 250 may be in communication with the turbine compartment air flow 225. The compressor bleed air flow 215 thus is the motive fluid that provides suction for the turbine compartment air flow 225. The eductor 230 also may include a mixing tube 260 and a diffusor 270. The educator 230 may have any suitable size, shape, configuration, or capacity. Other types of mixers, mixing pumps, and the like may be used as the educator 230 and the like. Other components and other configurations may be used herein.

The compressor bleed air flow 215 enters the motive inlet 240 as the motive flow and is reduced in pressure below that of the turbine compartment air flow 225 as the suction flow is accelerated therewith. The flows are mixed in the mixing tube 260 and flow through the diffusor 270 as a blended air flow 280. The blended air flow 280 thus is a combination of the turbine compartment air and the bleed heat blended to achieve overall temperature uniformity. The blended air flow 280 may be discharged at a pressure greater than the suction stream yet lower than the motive stream. Given such, the turbine compartment air flow 225 at the suction inlet 250 may be at a negative pressure or a vacuum. Specifically, overall suction capability for the educator 230 may be based upon the net positive suction head available therein. Multiple eductors 230 may be used herein so as to provide any number of blended flows 280 for cooling or otherwise.

The blended flow 280 may be routed to the turbine 170 so as to cool the later stages and the components thereof A number of control valves 290, control sensors 300, temperature sensors 310, and other types of controls and sensors may be used herein. Overall operations of the turndown cooling system 170 may be controlled by the overall gas turbine control (e.g., a “GE Speedtronic” controller or a similar device) or a dedicated controller per the optimization logic. (“Speedtronic is a trademark of the General Electric Company of Schenectady, N.Y.) Other components and other configurations also may be used herein.

FIG. 3 shows the turndown cooling system 200 in further detail. Specifically, the compressor bleed air source 210 may be a ninth stage compressor bleed air extraction 320, a thirteen stage compressor bleed air extraction 330, and/or an extraction from elsewhere. Generally described, the compressor bleed air extractions 320, 330 may be used for cooling the later stages of the turbine 170. In this example, the thirteen stage compressor bleed air extraction 330 may be used to cool a second stage 340 of the turbine. The ninth stage compressor bleed air extraction 320 may be in communication with the eductor 230 as described above so as to cool a third stage 350 or other later stage of the turbine 170 with the blended air flow 280. The blended air flow 280 may cool the stages and the components thereof. Other components and other configurations may be used herein.

The turndown cooling system 200 thus combines the compressor bleed air flow 215 and the turbine compartment air flow 225 to form the blended air flow 280 so as to optimize later stage cooling. The turndown cooling system 200 may have little to no impact on the compressor inlet or the turbine exhaust such that the gas turbine engine 100 operating in largely hibernation mode may maintain the desired fuel-air ratio so as to limit overall emissions within existing standards. The gas turbine engine 100 thus may operate with exhaust gas temperatures within the inlet temperature limits of the heat recovery steam generator during any operating mode so as to improve overall combined cycle capacity and steam producing capability. Moreover, the turndown cooling system 200 also may provide the gas turbine engine 100 with the ability for fast ramp up to base load. The gas turbine engine 100 thus may reach hibernation mode of less than about thirty percent (30%) of base load, possibly within about the twenty to twenty-five percent (20-25%) load range, or possibly as low as about ten percent (10%) or so. Other percentages and other loads may be used herein.

The turndown cooling system 200 thus delivers a previously unavailable operating range for the gas turbine engine 100. The turndown cooling system 200 may require minimal additional components with no design changes to the overall gas turbine engine 100. The turndown cooling system 200 may optimize later stage turbine bucket temperatures via the blended air flow 280. Such cooling may prevent the turbine from exceeding overall temperature limitations so as to improve component lifetime. The turndown cooling system 200 may increase overall power plant reliability in that forced outages due to exceeding operational parameters and/or emission may be reduced. Moreover, improved overall performance may be provided by reducing the propensity for turndown limitations with improved part load heat rate. The overall gas turbine engine 100 further may increase the total hours of operation. The turndown cooling system 200 may be original equipment or part of a retrofit.

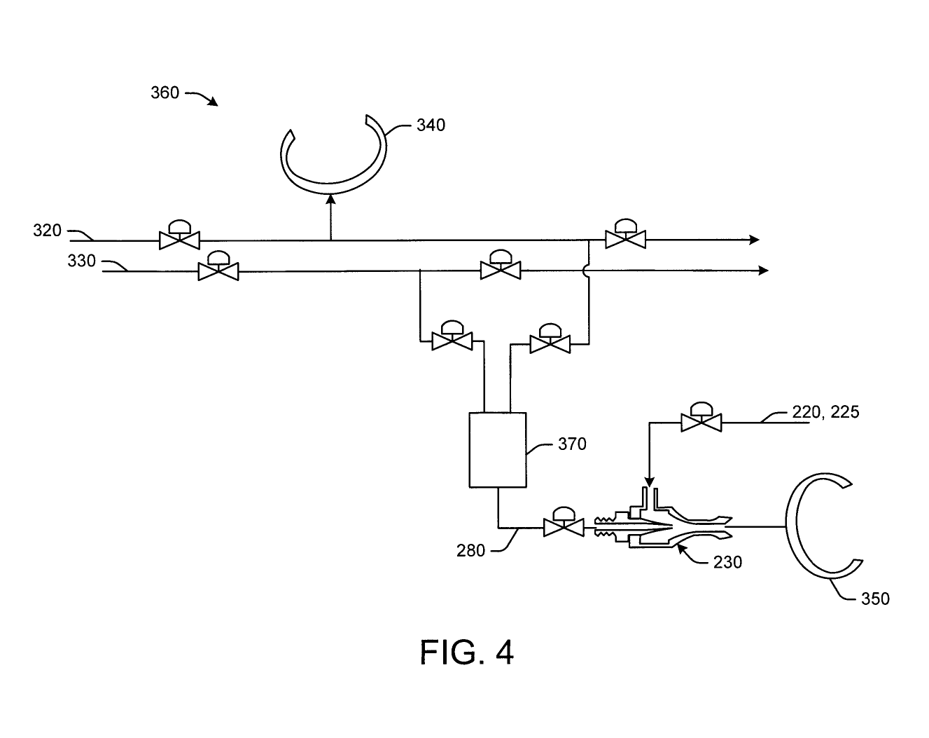

FIG. 4 shows a further embodiment of a turndown cooling system 360 as may be described herein. In this example, the source of compressor bleed air 210 may include both the ninth stage compressor bleed air extraction 320 and the thirteen stage compressor bleed air extraction 330. These flows may merge in a blending manifold 370 before being forwarded onto the eductor 230 or elsewhere. In this example, the blended flow 280 may be used to cool the third stage 350 of the turbine 170 or other later stage such as the fourth stage or otherwise. Other components and other configurations may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A gas turbine engine for low turndown operations, comprising:
a compressor;
the compressor comprising a compressor bleed air flow;
a turbine compartment;
the turbine compartment comprising a turbine compartment air flow;
a turbine; and
an eductor;
wherein the eductor blends the compressor bleed air flow and the turbine compartment air flow into a blended air flow for use in cooling the turbine.

2. The gas turbine engine of claim 1, wherein the compressor bleed air flow comprises a ninth stage compressor bleed air extraction.

3. The gas turbine engine of claim 1, wherein the compressor bleed air flow comprises a thirteen stage compressor bleed air extraction.

4. The gas turbine engine of claim 1, wherein the compressor bleed air flow comprises a blending manifold.

5. The gas turbine engine of claim 1, wherein the compressor bleed air flow comprises a blend of a ninth stage compressor bleed air extraction and a thirteen stage compressor bleed air extraction.

6. The gas turbine engine of claim 1, wherein the turbine compartment comprises a turbine compartment air source.

7. The gas turbine engine of claim 1, wherein the eductor comprises a motive inlet in communication with the compressor bleed air flow.

8. The gas turbine engine of claim 1, wherein the eductor comprises a suction inlet in communication with the turbine compartment air flow.

9. The gas turbine engine of claim 1, wherein the eductor comprises a mixing tube and a diffuser.

10. The gas turbine engine of claim 1, wherein the turbine comprises a plurality of stages.

11. The gas turbine engine of claim 1, wherein the blended air flow cools a second stage of the turbine.

12. The gas turbine engine of claim 1, wherein the blended air flow cools a third stage or a fourth stage of the turbine.

13. The gas turbine engine of claim 1, wherein the low turndown operations comprise less than about thirty percent (30%) of base load.

14. The gas turbine engine of claim 1, wherein the low turndown operations comprise about twenty to about twenty-five percent (20-25%) of base load.

15. A method of operating a gas turbine engine at low turndown, comprising:
operating the gas turbine engine at less than about thirty percent (30%) of base load;
directing a compressor bleed air flow to an eductor;
directing a turbine compartment air flow to the eductor;
blending the compressor bleed air flow and the turbine compartment air flow within the eductor into a blended air flow; and
providing the blended air flow to a turbine to cool one or more stages therein.

16. A low turndown system for use with a gas turbine engine, comprising:
a compressor bleed air flow from a compressor of the gas turbine engine;
a turbine compartment air flow from a turbine compartment; and
an eductor for blending the compressor bleed air flow and the turbine compartment air flow into a blended air flow for cooling one or more stages of a turbine of the gas turbine engine.

17. The low turndown system of claim 16, wherein the compressor bleed air flow comprises a ninth stage compressor bleed air extraction and/or a thirteen stage compressor bleed air extraction, and/or a blend of the ninth stage compressor bleed air extraction and the thirteen stage compressor bleed air extraction.

18. The low turndown system of claim 16, wherein the turbine compartment comprises a turbine compartment air source.

19. The low turndown system of claim 16, wherein the eductor comprises a motive inlet in communication with the compressor bleed air flow and a suction inlet in communication with the turbine compartment air flow.

20. The low turndown system of claim 16, wherein the gas turbine engine comprise a low turndown operation of less than about thirty percent (30%) of base load.
